(19) United States
(12) Patent Application Publication
(10) Pub. No.: US 2011/0169204 A1
(43) Pub. Date: Jul. 14, 2011

(54) CONSTRUCTION VEHICLE CAB SUSPENSION SURFACE EFFECT LIQUID MOUNT

(75) Inventors: David M. Catanzarite, Edinboro, PA (US); Petre Duncan Howorth, East Aurora, NY (US); Timothy J. Kubat, Erie, PA (US); Keith R. Ptak, Erie, PA (US)

(73) Assignee: Lord Corporation, Cary, NC (US)

(21) Appl. No.: 12/935,403

(22) PCT Filed: Apr. 2, 2009
(86) PCT No.: PCT/US09/39290

§ 371 Date: Mar. 17, 2011

Related U.S. Application Data
(60) Provisional application No. 61/041,782, filed on Apr. 2, 2008.
(60) Provisional application No. 61/128,094, filed on May 19, 2008.
(60) Provisional application No. 61/128,095, filed on May 19, 2008.

(51) Int. Cl. F16F 13/00; B23P 13/00

(52) U.S. Cl. 267/140.13; 29/896.91

(57) ABSTRACT

A vehicle suspension mount (20) for connection of a first vehicle body—structure (22) with a second vehicle body structure (24). The mount including a suspension mount damping liquid damper pumper member (42). An inner elastomeric shaft support assembly (52) including an inner elastomeric surface effect damper member (54) bonded with an inner nonelastomeric grounding member (56), the inner nonelastomeric grounding member (56) grounding the inner elastomeric surface effect damper member (54) with a first outer container member (26), with the inner elastomeric surface effect damper member (54) engaging a shaft nonelastomeric surface effect damper member (60), the inner elastomeric surface effect damper member (54) in alignment with a nonelastomeric center axial shaft axis (36) wherein a nonelastomeric center axial shaft (30) translates relative to the inner elastomeric surface effect damper member (58) with the inner elastomeric surface effect damper member (58) engaging the shaft nonelastomeric surface effect damper member (60) damping translation of the shaft nonelastomeric surface effect damper member (60) along the inner elastomeric surface effect damper member.

### CROSS REFERENCE

This application claims the benefit of, and incorporates by reference, U.S. Provisional Patent Application No. 61/041,782 filed on Apr. 2, 2008, and U.S. Provisional Patent Application Nos. 61/128,094 and 61/128,095 filed on May 19, 2008.

### FIELD OF THE INVENTION

The invention relates to the field of suspension mounts for connection between a first body structure and a second body structure. The invention relates to the field of construction vehicle cab suspension mounts for connecting a first vehicle body structure with a second vehicle body structure. More particularly the invention relates to the field of vehicle cab suspension mounts containing a mount liquid.

### SUMMARY OF THE INVENTION

In an embodiment the invention includes a vehicle suspension mount. The mount includes an outer container containing a mount damper liquid moved by a suspension mount damping liquid damper pumper member on a center axial shaft. The mount includes an inner elastomeric shaft support assembly disposed in the outer container between the suspension mount damping liquid damper pumper member and an outer cap member, the inner elastomeric shaft support assembly includes an inner elastomeric member grounded to the outer container, with the inner elastomeric member including a inner elastomeric surface effect damper member rubbing against the center shaft, the inner elastomeric surface effect damper member in alignment with the nonelastomeric center axial shaft axis wherein the nonelastomeric center axial shaft translates along the inner elastomeric surface effect damper member with the suspension mount damping liquid damper pumper member pumping the suspension mount damping liquid.

In an embodiment the invention includes a liquid mount, with a cup housing; a center axis shaft having an upper end and a lower end, the center axis shaft disposed along a central axis of the cup housing; a flexible seal cap sealing fluid-tight between the upper end of the shaft and the cup housing; a high viscosity liquid; a movable damping pumper mounted to the lower end of the shaft and in the high viscosity liquid; a spring disposed between a bottom of the cup housing and the movable damping pumper; an inner elastomeric shaft support assembly disposed in the housing between the damping pumper and the flexible seal cap, the inner elastomeric shaft support assembly having at least a first liquid flow conduit to allow a flow of the liquid in a direction from the movable damping pumper towards the flexible seal cap and in an opposite direction from the flexible seal cap towards the movable damping pumper, the inner elastomeric shaft support assembly including an inner elastomeric member bonded with an inner nonelastomeric grounding member, the inner nonelastomeric grounding member grounding the inner elastomeric member with the housing, with the inner elastomeric member supporting a inner elastomeric surface effect damper member against a surface effect damper surface of the center shaft, the inner elastomeric surface effect damper member in alignment with the central axis. In a preferred embodiment, the center axis shaft moves along the inner elastomeric surface effect damper member with the pumper pumping the liquid with a reduced level of damping at a high frequency range with low amplitude oscillations compared to an increased level of damping at a low frequency range with high amplitude movements.

In an embodiment the invention includes a method of making a vehicle cab suspension mount. The method includes providing a first outer container member. The method includes providing a nonelastomeric center axial shaft and an outer elastomeric flexible seal cap with said outer elastomeric cap grounded radially outward to said first outer container member, said nonelastomeric center axial shaft longitudinally extending inward into said first outer container member along a shaft axis, with said nonelastomeric center shaft having a terminal end. The method includes disposing a suspension mount damping liquid damper pumper member proximate said nonelastomeric center shaft terminal end. The method includes providing an inner elastomeric shaft support assembly in said first outer container member between said suspension mount damping liquid damper pumper member and said second outer cap member, said inner elastomeric shaft support assembly including an inner elastomeric member bonded with an inner nonelastomeric grounding member, said inner nonelastomeric grounding member grounding said inner elastomeric member with said first outer container member, with said inner elastomeric member supporting a inner elastomeric surface effect damper member for said nonelastomeric center shaft, said inner elastomeric surface effect damper member in alignment with said nonelastomeric center axial shaft axis wherein said nonelastomeric center axial shaft translates along said inner elastomeric surface effect damper member. The method includes filling said first outer container member with a vehicle cab suspension mount damping liquid wherein said suspension mount damping liquid damper pumper member pumps said vehicle cab suspension mount damping liquid when said nonelastomeric center axial shaft translates along said inner elastomeric surface effect damper member.

In an embodiment the invention includes a method of making a vehicle cab suspension mount, the method including: providing a first outer container member, providing a nonelastomeric center axial shaft and an outer elastomeric flexible seal cap with the outer elastomeric cap grounded radially outward to the first outer container member, the nonelastomeric center axial shaft longitudinally extending inward into the first outer container member along a shaft axis, with the nonelastomeric center shaft having a terminal end, disposing a suspension mount damping liquid damper pumper member proximate the nonelastomeric center shaft terminal end, providing an inner elastomeric intermediate assembly in the first outer container member between the suspension mount damping liquid damper pumper member and the outer cap member, the inner elastomeric assembly including an inner elastomeric member bonded with an inner nonelastomeric grounding member, the inner nonelastomeric grounding member grounding the inner elastomeric member with the first outer container member, with the inner elastomeric member extending inward from the container grounding member inward toward the shaft and separating the movable damping pumper from the flexible seal cap to provide a first flexible seal cap chamber and a second movable damping pumper chamber, the inner elastomeric assembly having at least a first liquid flow conduit between the first flexible seal cap chamber and the second movable damping pumper chamber to allow a flow of the liquid in a direction from the movable damping pumper towards the flexible seal cap and in an opposite direction from the flexible seal cap towards the movable damping pumper, the at least first liquid flow conduit distal from the nonelastomeric center axial shaft, filling the first outer container member with a vehicle cab suspension mount damping liquid wherein the suspension mount damping liquid damper pumper member pumps the vehicle cab suspension mount damping liquid with the liquid flowing through the first liquid flow conduit distal from the nonelastomeric center axial shaft.

In an embodiments the invention includes suspension mounts, including: a first outer container member, a nonelastomeric center axial shaft and means for controlling relative motion between the first outer container member and the nonelastomeric center axial shaft.

In an embodiments the invention includes suspension mounts, including: a first outer container member, a nonelastomeric center axial shaft and means for controlling relative motion between the first outer container member and the nonelastomeric center axial shaft as shown and described.

It is to be understood that both the foregoing general description and the following detailed description are exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principals and operation of the invention.

### BRIEF DESCRIPTION OF THE DRAWINGS

FIG. 1 illustrates liquid flow through liquid flow conduits in a vehicle suspension liquid mount from relative motion between a first vehicle body structure and a second vehicle body structure.

FIG. 2A-B illustrate a vehicle suspension liquid mount.

FIG. 3 illustrate a vehicle suspension liquid mount with a surface effect damper tubular member and showing the relative surface effect dimensions SHE, SEL, SEID, and SEOD.

FIG. 4A-D show a vehicle suspension liquid mount.

FIG. 5A-F show a liquid mount outer elastomeric flexible seal cap nonelastomeric center axial shaft mold bonded assembly with said outer elastomeric cap for radially grounding with the outer container member.

FIG. 6A-H show a liquid mount inner elastomeric intermediate mold bonded assembly, with an inner nonelastomeric grounding member and liquid flow conduits.

FIG. 7A-C show a surface effect damper tubular member for being received and mated to the axial shaft, and having the SEL and SEOD dimensions for engaging the surface effect elastomer.

FIG. 8-11 illustrate methods of making and assembling suspension liquid mounts and show the assembled liquid mounts.

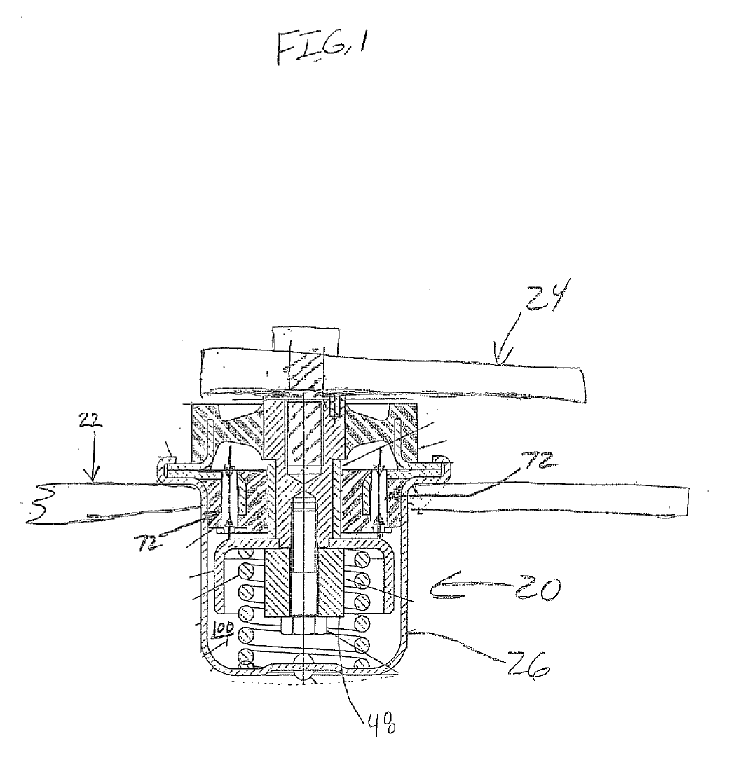

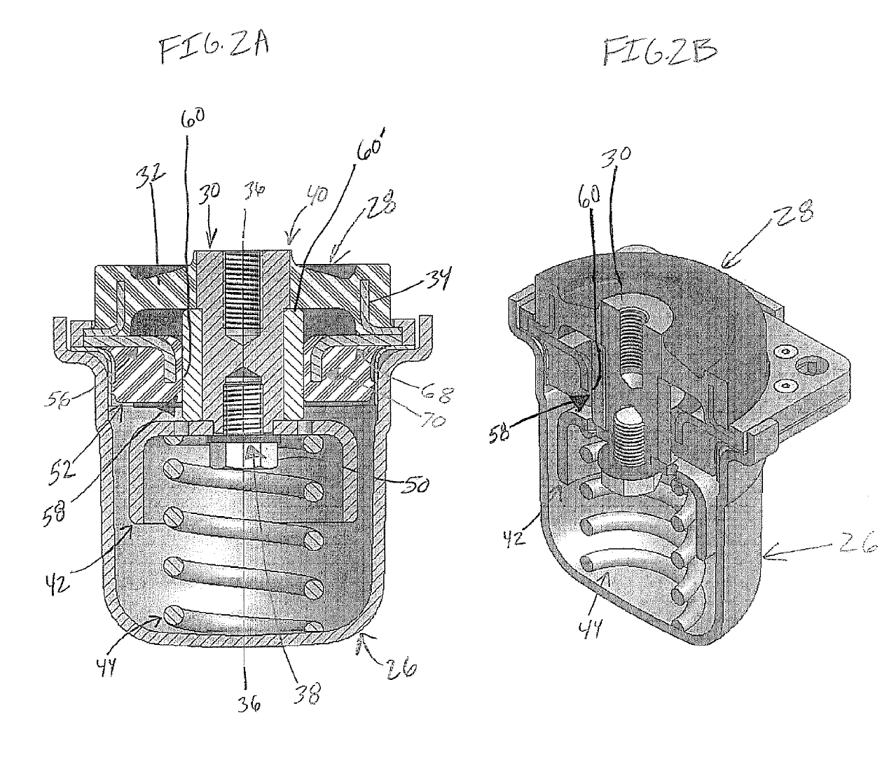

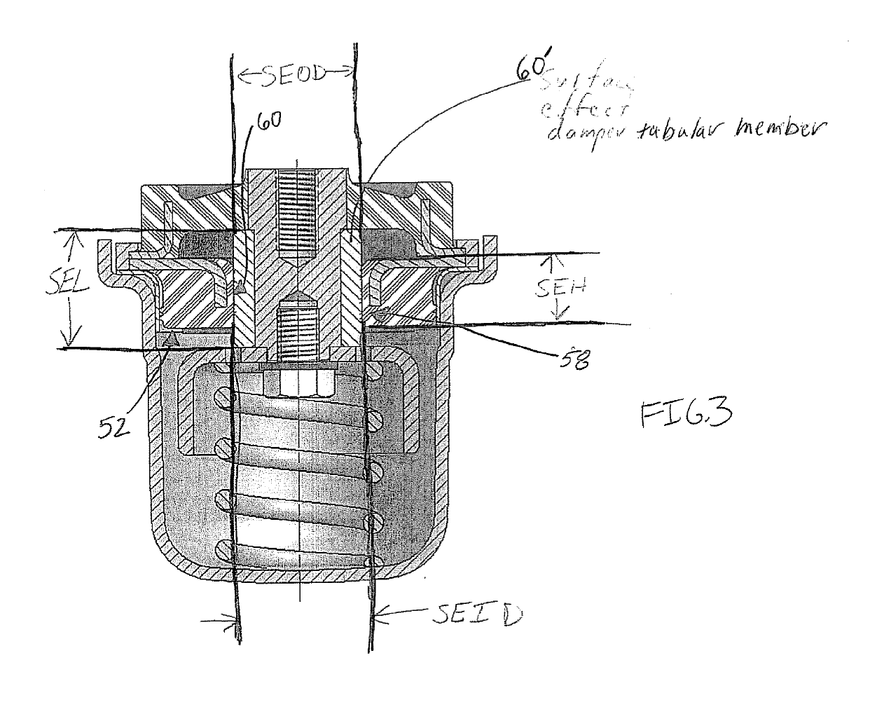

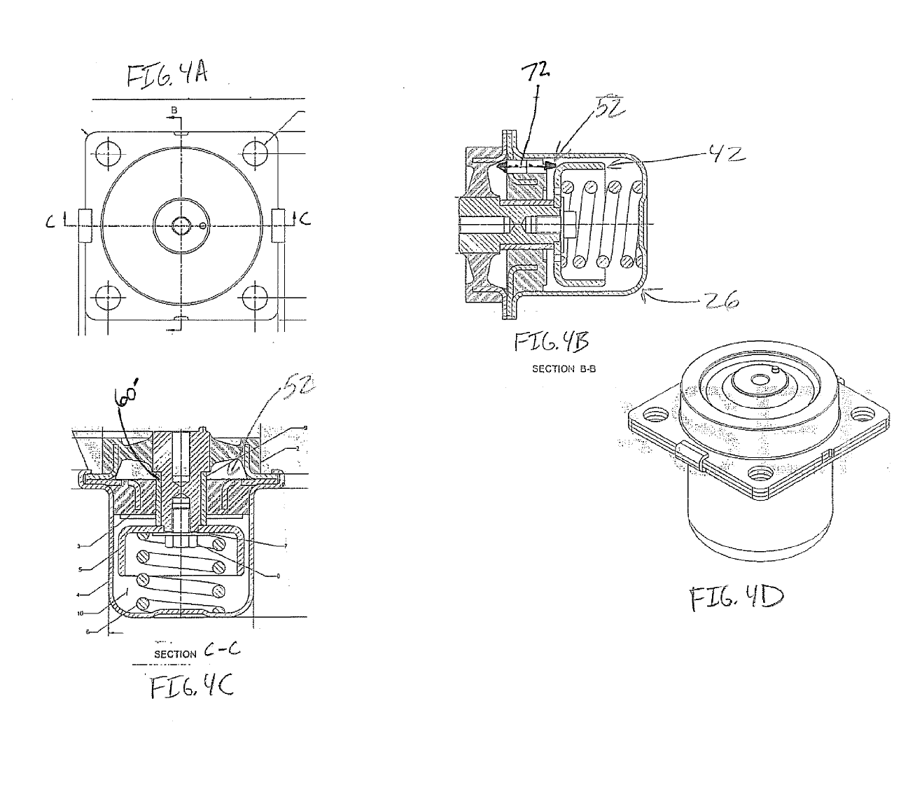

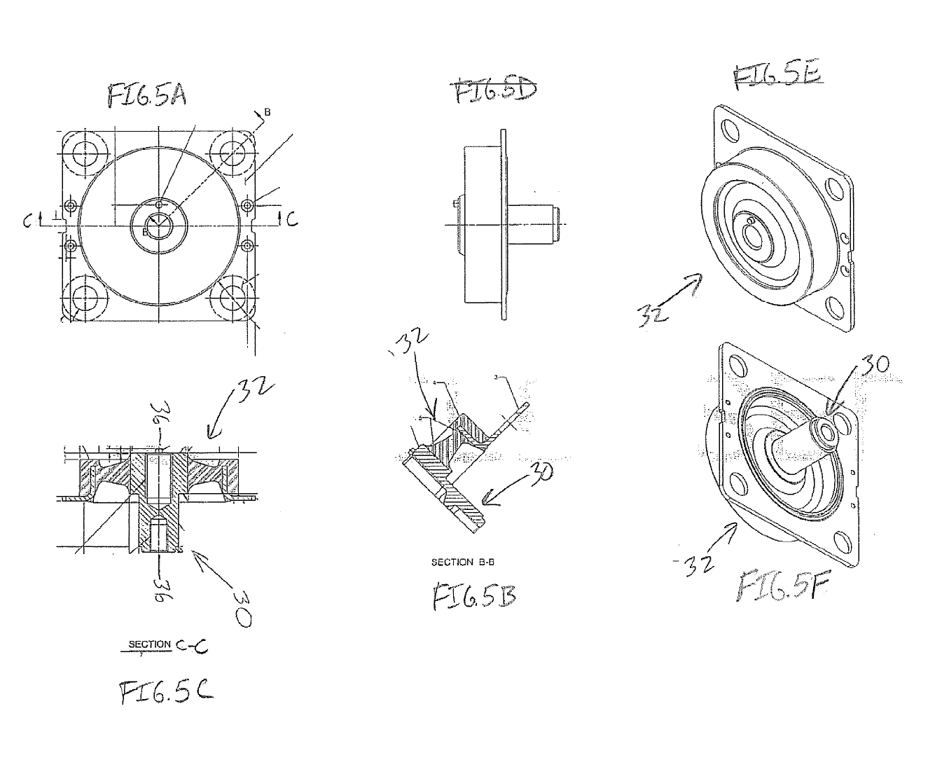

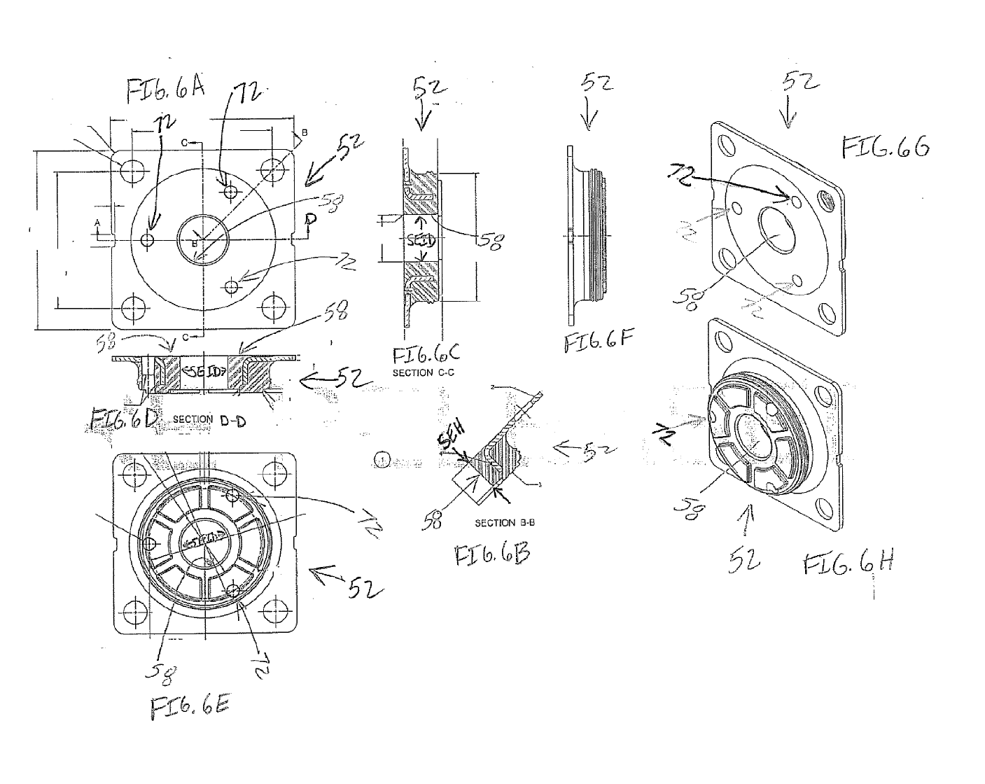

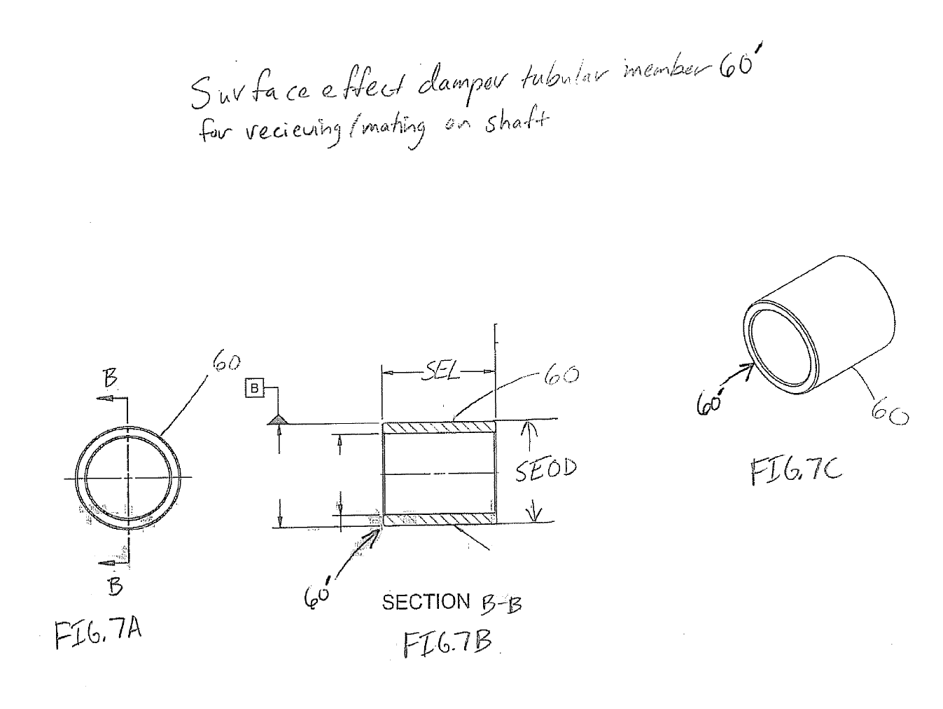

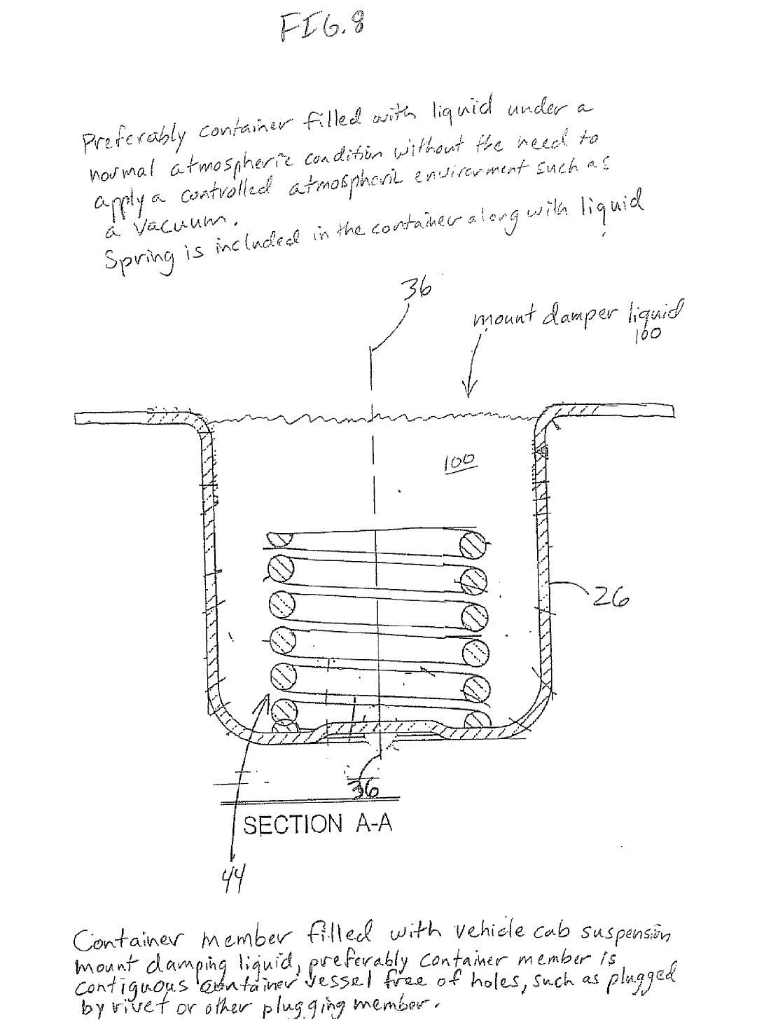

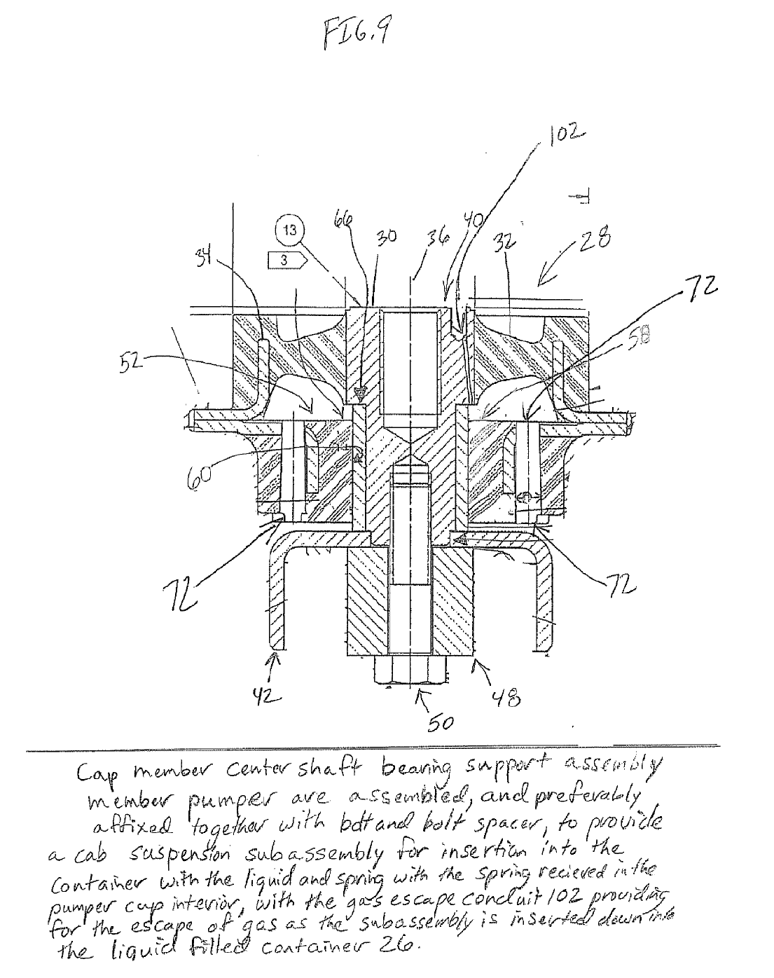

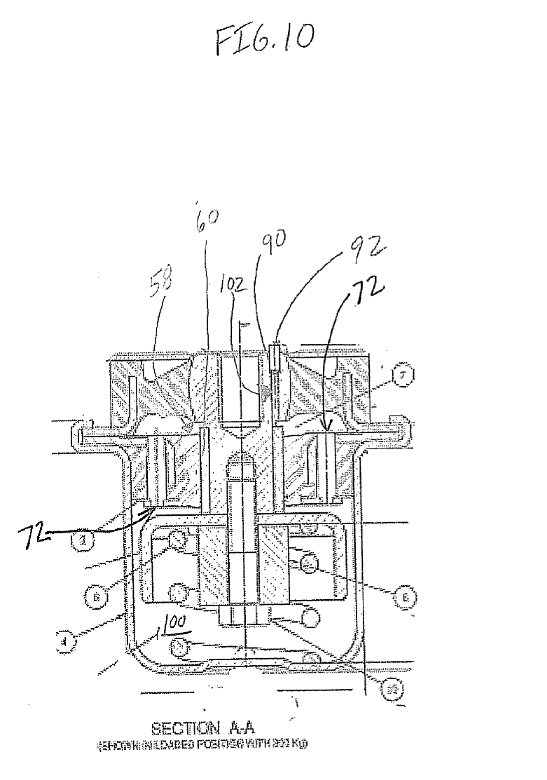

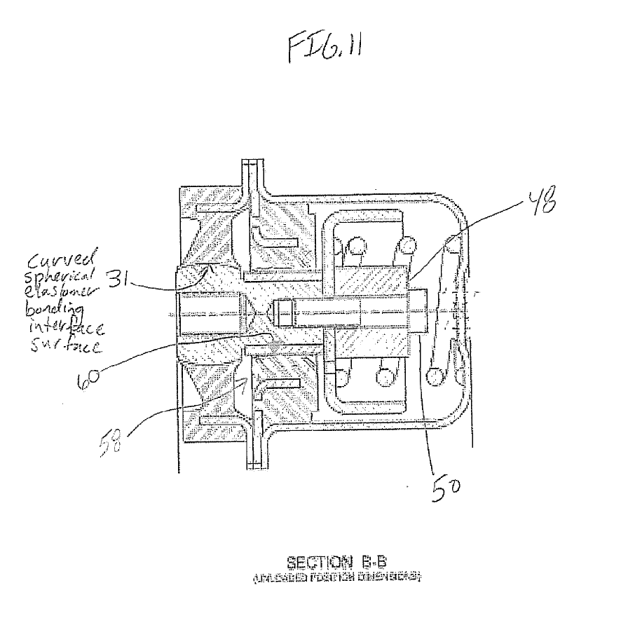

### DETAILED DESCRIPTION OF THE PREFERRED EMBODIMENT

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

Reference will now be made in detail to the present preferred embodiments of the invention, examples of which are illustrated in the accompanying drawings.

In an embodiment the invention includes a vehicle suspension mount for connection of a first vehicle body structure with a second vehicle body structure, the mount including a first outer container member, a second outer cap member, the second outer cap member having a nonelastomeric center axial shaft and an outer elastomeric cap with the outer elastomeric cap grounded radially outward to the first outer container member, the nonelastomeric center axial shaft longitudinally extending inward into the first outer container member along a shaft axis, with the nonelastomeric center shaft having a terminal end distal from the outer elastomeric cap, the nonelastomeric center shaft including a shaft nonelastomeric surface effect damper tubular member 60′ between the terminal end and the outer elastomeric cap. Preferably the shaft nonelastomeric surface effect damper member has a shaft surface effect SEOD outside diameter and the shaft nonelastomeric surface effect damper member has a shaft surface effect length SEL. The first outer container member and the second outer cap member containing a suspension mount damping liquid. The mount includes a suspension mount damping liquid damper pumper member, the suspension mount damping liquid damper pumper member fixed to the nonelastomeric center shaft proximate the terminal end. The mount includes an inner elastomeric shaft support assembly disposed in the first outer container member between the suspension mount damping liquid damper pumper member and the second outer cap member, the inner elastomeric shaft support assembly including an inner elastomeric surface effect damper member bonded with an inner nonelastomeric grounding member, the inner elastomeric surface effect damper member having an inner elastomeric surface effect damper member shaft engagement surface with a surface effect inside diameter SEID, and having an inner elastomeric surface effect damper member engagement surface effect height SEH. The inner nonelastomeric grounding member grounding the inner elastomeric surface effect damper member with the first outer container member, with the inner elastomeric surface effect damper member engaging the shaft nonelastomeric surface effect damper member, the inner elastomeric surface effect damper member in alignment with the nonelastomeric center axial shaft axis wherein the nonelastomeric center axial shaft translates relative to the inner elastomeric surface effect damper member with the inner elastomeric surface effect damper member engaging the shaft nonelastomeric surface effect damper member damping translation of the shaft nonelastomeric surface effect damper member along the inner elastomeric surface effect damper member and with the suspension mount damping liquid damper pumper member pumping the suspension mount damping liquid. Preferably the shaft surface effect SEOD>SEID, prefer SEOD>1.1SEID. Preferably the shaft surface effect SEL>SEH. Preferably the coil spring is disposed between the nonelastomeric center shaft terminal end and the first outer container member, preferably between damping cup pumper 44 and container 26 can bottom. Preferably the suspension mount damping liquid damper pumper is comprised of a suspension mount damping liquid damper pumper cupped member having a cup interior. Preferably a spring is disposed between the nonelastomeric center shaft terminal end and the first outer container member with the spring received in the cup interior. Preferably a bolt and a bolt spacer fix the suspension mount damping liquid damper pumper cupped member to the shaft, the bolt and a bolt spacer received in the cup interior. Preferably the shaft nonelastomeric surface effect damper tubular member 60′ is comprised of a nonmetallic shaft nonelastomeric surface effect damper tubular member, preferably a polymeric shaft nonelastomeric surface effect damper tubular member comprised of a polymer. Preferably the inner elastomeric surface effect damper member encompasses the shaft nonelastomeric surface effect damper tubular member, preferably with a smooth circular interface. Preferably the inner elastomeric shaft support assembly has at least a first liquid flow conduit to allow a flow of the liquid in a direction from the movable damping pumper towards the flexible seal cap and in an opposite direction from the flexible seal cap towards the movable damping pumper, the at least a first liquid flow conduit disposed between the inner elastomeric surface effect damper member and the first outer container member, preferably distal from the shaft and the shaft nonelastomeric surface effect damper member. Preferably the shaft nonelastomeric surface effect damper tubular member has an inside tubular diameter mated with an outside diameter of a segment of the nonelastomeric center shaft. Preferably the at least first liquid flow conduit is at least a first orifice, wherein the liquid damper pumper member pumps the liquid with a reduced level of damping at a high frequency range with low amplitude oscillations compared to an increased level of damping at a low frequency range with high amplitude movements. Preferably the inner nonelastomeric grounding member includes a radially inwardly extending flange plate and a substantially normal axially extending extension.

In an embodiment the invention includes a liquid mount, comprising: a cup housing having a mounting flange; a center axis shaft having an upper end and a lower end, the center axis shaft having a middle outer circumference surface effect engagement surface between the upper end and the lower end, the center axis shaft disposed along a central axis of the cup housing; a flexible seal cap sealing fluid-tight between the upper end of the shaft and the cup housing; a high viscosity liquid; a movable damping pumper mounted to the lower end of the shaft and in the high viscosity liquid; a spring disposed between a bottom of the cup housing and the movable damping pumper; an inner elastomeric shaft support surface effect damper assembly disposed in the housing between the damping pumper and the flexible seal cap, the inner elastomeric shaft support surface effect damper assembly having at least a first liquid flow conduit to allow a flow of the liquid in a direction from the movable damping pumper towards the flexible seal cap and in an opposite direction from the flexible seal cap towards the movable damping pumper, the inner elastomeric shaft support surface effect damper assembly including an inner elastomeric surface effect damper member bonded with an inner nonelastomeric grounding member, the inner nonelastomeric grounding member grounding the inner elastomeric surface effect damper member with the housing, with the inner elastomeric surface effect damper member having an inner elastomeric surface effect damper member engagement surface effect internal circumference having SEID inside diameter and inner elastomeric surface effect damper member engagement surface effect height SEH, the inner elastomeric surface effect damper member engagement surface effect internal circumference engaging the center axis shaft middle outer circumference surface effect engagement surface, with the inner elastomeric surface effect damper member in alignment with the central axis wherein inner elastomeric surface effect damper member engagement surface effect internal circumference dampens motion of the middle outer circumference surface effect engagement surface and the center axis shaft movement along the inner elastomeric surface effect damper member pumps the liquid with the movable damping pumper with a reduced level of damping at a high frequency range with low amplitude oscillations compared to an increased level of damping at a low frequency range with high amplitude movements. Preferably the center axis shaft comprised of a shaft nonelastomeric surface effect damper tubular member, the shaft nonelastomeric surface effect damper tubular member having the middle outer circumference surface effect engagement surface, the shaft nonelastomeric surface effect damper tubular member received and mated to and on the center axis shaft between flexible seal cap and the movable damping pumper. Preferably the center axis shaft middle outer circumference surface effect engagement surface having a shaft surface effect outside diameter SEOD, and the inner elastomeric surface effect damper member engagement surface effect internal circumference having a surface effect inside diameter SEID with SEOD>SEID, preferably SEOD≧1.1SEID. Preferably the center axis shaft middle outer circumference surface effect engagement surface having a shaft surface effect length SEL, and the inner elastomeric surface effect damper member engagement surface effect internal circumference having a surface effect height SEH with SEL>SEH. Preferably the shaft nonelastomeric surface effect damper tubular member is comprised of a polymer. Preferably the at least first liquid flow conduit is comprised of at least a first orifice, the at least first orifice distal from the center axis shaft.

In an embodiment the invention includes a method of making a vehicle cab suspension mount, the method including providing a first outer container member, providing a nonelastomeric center axial shaft and an outer elastomeric flexible seal cap with the outer elastomeric cap grounded radially outward to the first outer container member, the nonelastomeric center axial shaft longitudinally extending inward into the first outer container member along a shaft axis, with the nonelastomeric center shaft having a terminal end, disposing a suspension mount damping liquid damper pumper member proximate the nonelastomeric center shaft terminal end, providing an inner elastomeric shaft support assembly in the first outer container member between the suspension mount damping liquid damper pumper member and the second outer cap member, the inner elastomeric shaft support assembly including an inner elastomeric surface effect member bonded with an inner nonelastomeric grounding member, the inner nonelastomeric grounding member grounding the inner elastomeric surface effect member with the first outer container member, with the inner elastomeric surface effect member encircling the nonelastomeric center shaft, the inner elastomeric surface effect member in alignment with the nonelastomeric center axial shaft axis wherein the nonelastomeric center axial shaft translates along the inner elastomeric surface effect member, filling the first outer container member with a vehicle cab suspension mount damping liquid wherein the suspension mount damping liquid damper pumper member pumps the vehicle cab suspension mount damping liquid when the nonelastomeric center axial shaft translates along the inner elastomeric surface effect member. Preferably the method includes proving a coil spring, and disposing the coil spring between the nonelastomeric center shaft terminal end and the first outer container member, preferably between the pumper cup plate member and the container bottom end. Preferably the suspension mount damping liquid damper pumper is comprised of a suspension mount damping liquid damper pumper cupped member having a cup interior. Preferably the method includes providing a spring, the spring disposed between the nonelastomeric center shaft terminal end and the first outer container member with the spring received in the cup interior. Preferably the method includes providing a bolt and a bolt spacer and fixing the suspension mount damping liquid damper pumper cupped member to the shaft with the bolt and the bolt spacer, the bolt and the bolt spacer received in the cup interior. Preferably the method includes providing a bolt and a bolt spacer fixing the suspension mount damping liquid damper pumper cupped member to the shaft, and a suspension spring, the bolt, the bolt spacer, and the suspension spring received in the cup interior. Preferably wherein the center axial shaft includes a shaft nonelastomeric surface effect damper tubular member, the shaft nonelastomeric surface effect damper tubular member having an outer circumference surface effect engagement surface, the shaft nonelastomeric surface effect damper tubular member mated to the center axial shaft, between the flexible seal cap and the damping pumper. Preferably the shaft nonelastomeric surface effect damper tubular member has an outer circumference surface effect engagement surface outside diameter SEOD and the inner elastomeric surface effect member has a surface effect inside diameter SEID with SEOD>SEID. Preferably the shaft nonelastomeric surface effect damper member has a shaft surface effect length SEL with SEL>SEH. Preferably the shaft nonelastomeric surface effect damper tubular member is comprised of a polymer. Preferably the shaft has a shaft surface effect length SEL, and the inner elastomeric surface effect damper member engagement surface effect internal circumference has a surface effect height SEH with SEL>SEH. Preferably the method includes providing the nonelastomeric center axial shaft with a conduit and allowing a displaced gas to exit the conduit, during assembly gas is allowed to escape, shaft conduit is preferably then plugged, preferably an off center conduit-away from center axis, anti-rotation dowel pin off set from center bolt hole, preferably no rivet plug in housing bottom for filling the liquid is utilized. Preferably the inner nonelastomeric grounding member includes a radially inwardly extending flange plate and a substantially normal axially extending extension. Preferably the method includes providing providing at least a first liquid flow conduit in the inner elastomeric shaft support assembly to allow a flow of the liquid in a direction from the movable damping pumper towards the flexible seal cap and in an opposite direction from the flexible seal cap towards the movable damping pumper wherein the shaft moves along the inner elastomeric surface effect member with the pumper pumping the liquid with a reduced level of damping at a high frequency range with low amplitude oscillations compared to an increased level of damping at a low frequency range with high amplitude movements. Preferably the method includes adjusting an orifice size of the at least first liquid flow conduit to tune the high frequency range.

In an embodiment the invention includes a construction vehicle cab suspension mount (20) for connection a first vehicle body structure (22) with a second vehicle body structure (24). The mount (20) includes a first outer container member (26), preferably with flanges and attachment features for attachment with the first vehicle body structure 22, preferably with fixture holes for attaching and securing the first outer container member (26) to the first vehicle body structure (22), preferably the first outer container member (26) is formed from a metal, preferably the first outer container member (26) is comprised of a steel container member.

The mount (20) includes a second outer cap member (28), the second outer cap member (28) having a nonelastomeric center axial shaft (30) and an outer elastomeric cap (32) with the outer elastomeric cap (32) grounded radially outward to the first outer container member (26), the nonelastomeric center axial shaft (30) longitudinally extending inward into the first outer container member along a shaft axis (36), with the nonelastomeric center shaft (30) having a terminal end (38) distal from the outer elastomeric cap (32). Preferably the center shaft is bonded to the outer elastomeric cap at a first shaft end (40), preferably at an outer elastomeric cap radially inward inner diameter with the outer elastomeric cap preferably bonded to an outer nonelastomeric cap radially outward outer nonelastomeric grounding member (34) at an outer elastomeric cap radially outward outboard shaft diameter. Preferably the nonelastomeric center shaft (30) includes attachment features for attachment with the second vehicle body structure (24).

The first outer container member (26) and the second outer cap member (28) contain a suspension mount damping liquid.

The mount (20) includes a suspension mount damping liquid damper pumper member (42), the suspension mount damping liquid damper pumper member (42) fixed to the nonelastomeric center shaft (30) proximate the terminal end (38). The suspension mount damping liquid damper pumper member (42) preferably also receives spring (44). The suspension mount damping liquid damper pumper member (42) is preferably a cupped member with the spring received in a cup interior (46), preferably the bolt spacer (48) and bolt (50) attached to the terminal end inside the cup interior.

The mount (20) includes an inner elastomeric shaft support assembly (52) disposed in the first outer container member (26) between the suspension mount damping liquid damper pumper member (42) and the second outer cap member (28), the inner elastomeric shaft support assembly (52) including an inner elastomeric member (54) bonded with an inner nonelastomeric grounding member (56), the inner nonelastomeric outer grounding member grounding the inner elastomeric member with the first outer container member (26), with the inner elastomeric member (54) supporting a inner elastomeric surface effect damper member (58) against a surface (60) of the nonelastomeric center shaft (30), the inner elastomeric surface effect damper member in alignment with the nonelastomeric center axial shaft axis (36) wherein the nonelastomeric center axial shaft (30) translates along the inner elastomeric surface effect damper member (58) with the suspension mount damping liquid damper pumper member (42) pumping the suspension mount damping liquid.

The vehicle suspension mount includes a coil spring (44), the coil spring disposed between the nonelastomeric center shaft terminal end and the first outer container member. Preferably the coil spring 44 is disposed between the damping cup pumper 42 and the first outer container member 26 bottom end.

The vehicle suspension mount includes the suspension mount damping liquid damper pumper comprised of a suspension mount damping liquid damper pumper cupped member having a cup interior (46). Preferably the mount includes a suspension spring (44), the spring (44) disposed between the nonelastomeric center shaft terminal end (38) and the first outer container member with the spring (44) received in the cup interior (46). Preferably the mount includes a bolt (50) and a bolt spacer (48) fixing the suspension mount damping liquid damper pumper cupped member to the shaft, the bolt and a bolt spacer received in the cup interior. Preferably the mount includes a bolt and a bolt spacer fixing the suspension mount damping liquid damper pumper cupped member to the shaft, and a suspension spring, the bolt, the bolt spacer, and the suspension spring received in the cup interior.

Preferably the inner nonelastomeric grounding member (56) includes a radially inwardly extending flange plate (68) and a substantially normal axially extending extension (70), preferably extending axially away from the cap and toward the pumper, preferably in alignment with the shaft axis, preferably with the elastomer between the axial extension and the shaft, preferably an elastomeric tubular section shape between the axial extension and the shaft providing the inner elastomeric surface effect damper member, preferably having inner elastomeric surface effect damper member engagement surface effect SEID inside diameter and inner elastomeric surface effect damper member engagement surface effect height SEH.

In an embodiment the invention includes the methods of making the vehicle suspension mount 20.

In an embodiment the invention includes a vehicle cab suspension liquid mount and the method of making such liquid mount, said liquid mount comprising a cup housing having a mounting flange. The liquid mount comprising a center axis shaft having an upper end and a lower end, the center axis shaft disposed along a central axis of the cup housing. The liquid mount comprising a flexible seal cap sealing fluid-tight between the upper end of the shaft and the cup housing. The liquid mount containing a high viscosity liquid, preferably a greater than 10,000 centistokes high viscosity liquid (prefer >20,000; >30,000; >40,000; >50,000; prefer in the 50,000 to 150,000 cSt, prefer in the 50,000 to 70,000 centistokes range, preferably a silicone liquid). The liquid mount comprising a movable damping pumper mounted to the lower end of the shaft and in the high viscosity liquid. The liquid mount comprising a spring disposed between a bottom of the cup housing and the movable damping pumper. The liquid mount comprising an inner elastomeric shaft support assembly disposed in the housing between the damping pumper and the flexible seal cap (28), the inner elastomeric shaft support assembly having at least a first liquid flow conduit (72) to allow a flow of the liquid in a direction from the movable damping pumper towards the flexible seal cap and in an opposite direction from the flexible seal cap towards the movable damping pumper, the inner elastomeric shaft support assembly including an inner elastomeric member bonded with an inner nonelastomeric grounding member, the inner nonelastomeric grounding member grounding the inner elastomeric member with the housing (26), with the inner elastomeric member supporting an inner elastomeric surface effect damper member engagement surface effect SEID inside diameter against a surface effect damper surface of the center shaft (30), the inner elastomeric surface effect damper member engagement surface effect SEID inside diameter in alignment with the central axis wherein the center axis shaft moves along the inner elastomeric surface effect damper member engagement surface with the pumper pumping the liquid, preferably with a reduced level of damping at a high frequency range with low amplitude oscillations compared to an increased level of damping at a low frequency range with high amplitude movements. Preferably damping at high frequencies and low amplitudes is reduced. Preferably liquid mount at least a first liquid flow conduit (72) includes a plurality of distributed conduits with liquid flows through the conduits 72. Preferably the invention includes methods and systems with variety of conduit orifice sizes, such as diameters, and changing the sizes to adjust and tune the high frequencies and to tune isolation of low amplitude oscillations at the tuned to high frequencies. Preferably the methods of making such vehicle cab suspension liquid mount include adjusting conduit flow volume to adjust/tune the frequencies and reduce the damping of high frequencies with low amplitudes.

In an embodiment the invention includes making the vehicle cab suspension liquid mounts. The methods include providing a first outer container member. The methods including providing a nonelastomeric center axial shaft and an outer elastomeric flexible seal cap with the outer elastomeric cap grounded radially outward to the first outer container member, the nonelastomeric center axial shaft longitudinally extending inward into the first outer container member along a shaft axis, with the nonelastomeric center shaft having a terminal end.

The methods include disposing a suspension mount damping liquid damper pumper member proximate the nonelastomeric center shaft terminal end.

The methods include providing an inner elastomeric shaft support assembly in the first outer container member between the suspension mount damping liquid damper pumper member and the second outer cap member, the inner elastomeric shaft support assembly including an inner elastomeric member bonded with an inner nonelastomeric grounding member, the inner nonelastomeric grounding member grounding the inner elastomeric member with the first outer container member, with the inner elastomeric member supporting a inner elastomeric surface effect damper member engagement surface for the nonelastomeric center shaft, the inner elastomeric surface effect damper member engagement surface in alignment with the nonelastomeric center axial shaft axis wherein the nonelastomeric center axial shaft translates along the inner elastomeric surface effect damper member engagement surface.

The methods include filling the first outer container member with a vehicle cab suspension mount damping liquid wherein the suspension mount damping liquid damper pumper member pumps the vehicle cab suspension mount damping liquid when the nonelastomeric center axial shaft translates along the inner elastomeric surface effect damper member engagement surface.

The methods include proving a coil spring, and disposing the coil spring between the nonelastomeric center shaft terminal end and the first outer container member.

Preferably the suspension mount damping liquid damper pumper is comprised of a suspension mount damping liquid damper pumper cupped member having a cup interior (46).

The methods include providing a spring (44), the spring (44) disposed between the nonelastomeric center shaft terminal end (38) and the first outer container member with the spring (44) received in the cup interior (46). Preferably the method includes a providing a bolt (50) and a bolt spacer (48) and fixing the suspension mount damping liquid damper pumper cupped member to the shaft with the bolt and the bolt spacer, the bolt and the bolt spacer received in the cup interior. Preferably the method includes a bolt and a bolt spacer fixing the suspension mount damping liquid damper pumper cupped member to the shaft, and a suspension spring, the bolt, the bolt spacer, received in the cup interior.

The methods include providing the inner nonelastomeric grounding member (56) including a radially inwardly extending flange plate (68) and a substantially normal axially extending extension.

Preferred methods and mount assemblies are illustrated in the figures on pages 8 through 11. Preferably the container 26 is hole free, in that is free of holes which require plugging with a plug member such as a rivet or other such plugging member, particularly the bottom of the container proximate the spring and the center axis 36 is hole free. Preferably the spring 44 is disposed in the container and aligned with the center axis 36 and the container is filled with the mount damping liquid 100. Preferably such liquid container assembly method is done under normal atmospheric conditions without the application of a vacuum such as assembly inside a vacuum chamber or some type of pressure vessel. As shown on FIG. page 9 the balance of the mount in terms of the cap member center shaft, bearing, bearing support assembly member, and pumper member are preferably assembled together with the bolt and bolt spacer to provide a cab suspension subassembly for insertion down into the liquid filled container which already contains the spring and liquid. Preferably the cab suspension subassembly includes a air gas escape conduit 102 for escape of air gas as the subassembly is inserted down into the liquid filled container. Preferably the assembled mount interior nonsolid free space is at least ninety percent filled with the liquid, more preferably at least ninety four precent filled with the liquid, preferably the liquid comprises ninety six to ninety eight percent of the assembled mount interior nonsolid free space with the balance being the air gas. Preferably the gas escape conduit 102 is formed in the nonelastomeric center shaft member 30, most preferably distal and offset from the axis 36, preferably through the antirotation dowel pin plug hole 90. Preferably the gas escape conduit 102 is plugged by the antirotation dowel plug nonelastomeric steel metal pin 92 which is press fit in the hole 90. In alternative preferred embodiments an adhesive sealant is used in addition to antirotation dowel plug pin 92 to plug the gas escape conduit 102. Preferably the nonelastomeric center shaft 30 is bonded with the outer elastomeric cap 32 with a curved shaft elastomer bonding interface surface 31, most preferably a spherically curvature curved shaft elastomer bonding interface surface 31 such as shown in FIG. pages 10 and 11.

The methods include providing at least a first liquid flow conduit (72) in the inner elastomeric shaft support assembly to allow a flow of the liquid in a direction from the movable damping pumper towards the flexible seal cap and in an opposite direction from the flexible seal cap towards the movable damping pumper wherein the shaft moves along the inner elastomeric surface effect damper member engagement surface with the pumper pumping the liquid, preferably with a reduced level of damping at a high frequency range with low amplitude oscillations compared to an increased level of damping at a low frequency range with high amplitude movements. Preferably including adjusting an orifice size of the provided at least first liquid flow conduit to tune the high frequency range to provide low amplitude decoupling. In an embodiment providing at least a first liquid flow conduit (72) in the inner elastomeric shaft support assembly includes providing a single orifice conduit in the inner elastomeric shaft support assembly to allow a flow of the liquid in a direction from the movable damping pumper towards the flexible seal cap and in an opposite direction from the flexible seal cap towards the movable damping pumper. In an embodiment providing a single orifice conduit in the inner elastomeric shaft support assembly to allow a flow of the liquid in a direction from the movable damping pumper towards the flexible seal cap and in an opposite direction from the flexible seal cap towards the movable damping pumper includes plugging all other remaining orifices.

In an embodiment the invention includes a method of making a vehicle cab suspension mount, the method including: providing a first outer container member, providing a nonelastomeric center axial shaft and an outer elastomeric flexible seal cap with the outer elastomeric cap grounded radially outward to the first outer container member, the nonelastomeric center axial shaft longitudinally extending inward into the first outer container member along a shaft axis, with the nonelastomeric center shaft having a terminal end, disposing a suspension mount damping liquid damper pumper member proximate the nonelastomeric center shaft terminal end, providing an inner elastomeric intermediate assembly in the first outer container member between the suspension mount damping liquid damper pumper member and the outer cap member, the inner elastomeric assembly including an inner elastomeric member bonded with an inner nonelastomeric grounding member, the inner nonelastomeric grounding member grounding the inner elastomeric member with the first outer container member, with the inner elastomeric member extending inward from the container grounding member inward toward the shaft and separating the movable damping pumper from the flexible seal cap to provide a first flexible seal cap chamber and a second movable damping pumper chamber, the inner elastomeric assembly having at least a first liquid flow conduit between the first flexible seal cap chamber and the second movable damping pumper chamber to allow a flow of the liquid in a direction from the movable damping pumper towards the flexible seal cap and in an opposite direction from the flexible seal cap towards the movable damping pumper, the at least first liquid flow conduit distal from the nonelastomeric center axial shaft, filling the first outer container member with a vehicle cab suspension mount damping liquid wherein the suspension mount damping liquid damper pumper member pumps the vehicle cab suspension mount damping liquid with the liquid flowing through the first liquid flow conduit distal from the nonelastomeric center axial shaft, preferably with said inner elastomeric intermediate assembly inhibiting liquid flow adjacent said shaft between said first flexible seal cap chamber and said second movable damping pumper chamber, preferably with the inner elastomeric intermediate assembly elastomer substantially fully engaging the center shaft with a press fit with no intentional gappage left there between with the elastomer engagement inhibiting liquid flow and relative motion with the surface effect damping.

In an embodiments the invention includes suspension mounts, including: a first outer container member, a nonelastomeric center axial shaft and means for controlling relative motion between the first outer container member and the nonelastomeric center axial shaft.

In an embodiments the invention includes suspension mounts, including: a first outer container member, a nonelastomeric center axial shaft and means for controlling relative motion between the first outer container member and the nonelastomeric center axial shaft as shown and described.

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

1. A vehicle suspension mount for connection of a first vehicle body structure with a second vehicle body structure, said mount including a first outer container member,
a second outer cap member, said second outer cap member having a nonelastomeric center axial shaft and an outer elastomeric cap with said outer elastomeric cap grounded radially outward to said first outer container member, said nonelastomeric center axial shaft longitudinally extending inward into said first outer container member along a shaft axis, with said nonelastomeric center shaft having a terminal end distal from said outer elastomeric cap, said nonelastomeric center shaft including a shaft nonelastomeric surface effect damper tubular member between said terminal end and said outer elastomeric cap, said first outer container member and said second outer cap member containing a suspension mount damping liquid,
a suspension mount damping liquid damper pumper member, said suspension mount damping liquid damper pumper member fixed to said nonelastomeric center shaft proximate said terminal end,
an inner elastomeric shaft support assembly disposed in said first outer container member between said suspension mount damping liquid damper pumper member and said second outer cap member, said inner elastomeric shaft support assembly including an inner elastomeric surface effect damper member bonded with an inner nonelastomeric grounding member, said inner nonelastomeric grounding member grounding said inner elastomeric surface effect damper member with said first outer container member, with said inner elastomeric surface effect damper member engaging said shaft nonelastomeric surface effect damper member, said inner elastomeric surface effect damper member in alignment with said nonelastomeric center axial shaft axis wherein said nonelastomeric center axial shaft translates relative to said inner elastomeric surface effect damper member with said inner elastomeric surface effect damper member engaging said shaft nonelastomeric surface effect damper member damping translation of said shaft nonelastomeric surface effect damper member along said inner elastomeric surface effect damper member and with said suspension mount damping liquid damper pumper member pumping said suspension mount damping liquid.

2. A vehicle suspension mount as claimed in claim 1 including a coil spring, said coil spring disposed between said nonelastomeric center shaft terminal end and said first outer container member.

3. A vehicle suspension mount as claimed in claim 1 said suspension mount damping liquid damper pumper comprised of a suspension mount damping liquid damper pumper cupped member having a cup interior.

4. A vehicle suspension mount as claimed in claim 3, including a spring, said spring disposed between said nonelastomeric center shaft terminal end and said first outer container member with said spring received in said cup interior.

5. A vehicle suspension mount as claimed in claim 3, including a bolt and a bolt spacer fixing said suspension mount damping liquid damper pumper cupped member to said shaft, said bolt and a bolt spacer received in said cup interior.

6. A vehicle suspension mount as claimed in claim 3, including a bolt and a bolt spacer fixing said suspension mount damping liquid damper pumper cupped member to said shaft, and a suspension spring, said bolt, said bolt spacer, and said suspension spring received in said cup interior.

7. A vehicle suspension mount as claimed in claim 1 wherein said shaft nonelastomeric surface effect damper tubular member is comprised of a nonmetallic shaft nonelastomeric surface effect damper tubular member

8. A vehicle suspension mount as claimed in claim 1 wherein said inner elastomeric surface effect damper member encompasses said shaft nonelastomeric surface effect damper tubular member.

9. A vehicle suspension mount as claimed in claim 1 said inner elastomeric shaft support assembly having at least a first liquid flow conduit to allow a flow of said liquid in a direction from said movable damping pumper towards said flexible seal cap and in an opposite direction from said flexible seal cap towards said movable damping pumper, said at least a first liquid flow conduit disposed between said inner elastomeric surface effect damper member and said first outer container member.

10. A vehicle suspension mount as claimed in claim 1 wherein said shaft nonelastomeric surface effect damper tubular member has an inside tubular diameter mated with an outside diameter of a segment of said nonelastomeric center shaft.

11. A vehicle suspension mount as claimed in claim 9 wherein said at least first liquid flow conduit is at least a first orifice, wherein said liquid damper pumper member pumps said liquid with a reduced level of damping at a high frequency range with low amplitude oscillations compared to an increased level of damping at a low frequency range with high amplitude movements.

12. A vehicle suspension mount as claimed in claim 1 wherein said inner nonelastomeric grounding member includes a radially inwardly extending flange plate and a substantially normal axially extending extension.

13. A liquid mount, comprising: a cup housing having a mounting flange; a center axis shaft having an upper end and a lower end, said center axis shaft having a middle outer circumference surface effect engagement surface between said upper end and said lower end, said center axis shaft disposed along a central axis of the cup housing; a flexible seal cap sealing fluid-tight between the upper end of the shaft and the cup housing; a liquid; a movable damping pumper mounted to the lower end of the shaft and in the liquid;
a spring disposed between a bottom of the cup housing and the movable damping pumper;
an inner elastomeric shaft support surface effect damper assembly disposed in said housing between said damping pumper and said flexible seal cap, said inner elastomeric shaft support surface effect damper assembly having at least a first liquid flow conduit to allow a flow of said liquid in a direction from said movable damping pumper towards said flexible seal cap and in an opposite direction from said flexible seal cap towards said movable damping pumper, said inner elastomeric shaft support surface effect damper assembly including an inner elastomeric surface effect damper member bonded with an inner nonelastomeric grounding member, said inner nonelastomeric grounding member grounding said inner elastomeric surface effect damper member with said housing, with said inner elastomeric surface effect damper member having an inner elastomeric surface effect damper member engagement surface effect internal circumference, said inner elastomeric surface effect damper member engagement surface effect internal circumference engaging said center axis shaft middle outer circumference surface effect engagement surface, with said inner elastomeric surface effect damper member in alignment with said central axis wherein inner elastomeric surface effect damper member engagement surface effect internal circumference dampens motion of said middle outer circumference surface effect engagement surface and said center axis shaft movement along said inner elastomeric surface effect damper member pumps said liquid with said movable damping pumper with a reduced level of damping at a high frequency range with low amplitude oscillations compared to an increased level of damping at a low frequency range with high amplitude movements.

14. A liquid mount as claimed in claim 13, said center axis shaft comprised of a shaft nonelastomeric surface effect damper tubular member, said shaft nonelastomeric surface effect damper tubular member having said middle outer circumference surface effect engagement surface, said shaft nonelastomeric surface effect damper tubular member received on said center axis shaft between flexible seal cap and said movable damping pumper.

15. A liquid mount as claimed in claim 13, said center axis shaft middle outer circumference surface effect engagement surface having a shaft surface effect outside diameter SEOD, and said inner elastomeric surface effect damper member engagement surface effect internal circumference having a surface effect inside diameter SEID with SEOD>SEID.

16. A liquid mount as claimed in claim 13, said center axis shaft middle outer circumference surface effect engagement surface having a shaft surface effect length SEL, and said inner elastomeric surface effect damper member engagement surface effect internal circumference having a surface effect height SEH with SEL>SEH.

17. A liquid mount as claimed in claim 14, wherein said shaft nonelastomeric surface effect damper tubular member is comprised of a polymer.

18. A liquid mount as claimed in claim 13, wherein said at least first liquid flow conduit is comprised of at least a first orifice, said at least first orifice distal from said center axis shaft.

19. A method of making a vehicle cab suspension mount, said method including:
providing a first outer container member,
providing a nonelastomeric center axial shaft and an outer elastomeric flexible seal cap with said outer elastomeric cap grounded radially outward to said first outer container member, said nonelastomeric center axial shaft longitudinally extending inward into said first outer container member along a shaft axis, with said nonelastomeric center shaft having a terminal end,
disposing a suspension mount damping liquid damper pumper member proximate said nonelastomeric center shaft terminal end,
providing an inner elastomeric shaft support assembly in said first outer container member between said suspension mount damping liquid damper pumper member and said second outer cap member, said inner elastomeric shaft support assembly including an inner elastomeric surface effect member bonded with an inner nonelastomeric grounding member, said inner nonelastomeric grounding member grounding said inner elastomeric surface effect member with said first outer container member, with said inner elastomeric surface effect member encirclingsaid nonelastomeric center shaft, said inner elastomeric surface effect member in alignment with said nonelastomeric center axial shaft axis wherein said nonelastomeric center axial shaft translates along said inner elastomeric surface effect member,
filling said first outer container member with a vehicle cab suspension mount damping liquid wherein said suspension mount damping liquid damper pumper member pumps said vehicle cab suspension mount damping liquid when said nonelastomeric center axial shaft translates along said inner elastomeric surface effect member.

20. A method as claimed in claim 19 including proving a coil spring, and disposing said coil spring between said nonelastomeric center shaft terminal end and said first outer container member.

21. A method as claimed in claim 19 wherein said suspension mount damping liquid damper pumper is comprised of a suspension mount damping liquid damper pumper cupped member having a cup interior.

22. A method as claimed in claim 21, including providing a spring, said spring disposed between said nonelastomeric center shaft terminal end and said first outer container member with said spring received in said cup interior.

23. A method as claimed in claim 21, including providing a bolt and a bolt spacer and fixing said suspension mount damping liquid damper pumper cupped member to said shaft with said bolt and said bolt spacer, said bolt and said bolt spacer received in said cup interior.

24. A method as claimed in claim 21, including a bolt and a bolt spacer fixing said suspension mount damping liquid damper pumper cupped member to said shaft, and a suspension spring, said bolt, said bolt spacer, and said suspension spring received in said cup interior.

25. A method as claimed in claim 19 wherein said said center axial shaft includes a shaft nonelastomeric surface effect damper tubular member, said shaft nonelastomeric surface effect damper tubular member having an outer circumference surface effect engagement surface, said shaft nonelastomeric surface effect damper tubular member mated to said center axial shaft.

26. A method as claimed in claim 25 wherein said shaft nonelastomeric surface effect damper tubular member has an outer circumference surface effect engagement surface outside diameter SEOD and said inner elastomeric surface effect member has a surface effect inside diameter SEID with SEOD>SEID.

27. A method as claimed in claim 25 wherein said shaft nonelastomeric surface effect damper tubular member is comprised of a polymer.

28. A method as claimed in claim 19 wherein said shaft has a shaft surface effect length SEL, and said inner elastomeric surface effect damper member engagement surface effect internal circumference has a surface effect height SEH with SEL>SEH.

29. A method as claimed in claim 19 including a providing said nonelastomeric center axial shaft with a conduit and allowing a gas to exit said conduit.

30. A method as claimed in claim 19 wherein said inner nonelastomeric grounding member includes a radially inwardly extending flange plate and a substantially normal axially extending extension.

31. A method as claimed in claim 19 including providing at least a first liquid flow conduit in said inner elastomeric shaft support assembly to allow a flow of said liquid in a direction from said movable damping pumper towards said flexible seal cap and in an opposite direction from said flexible seal cap towards said movable damping pumper wherein said shaft moves along said inner elastomeric surface effect member with said pumper pumping said liquid with a reduced level of damping at a high frequency range with low amplitude oscillations compared to an increased level of damping at a low frequency range with high amplitude movements.

32. A method as claimed in claim 31 including adjusting an orifice size of said provided at least first liquid flow conduit to tune said high frequency range.

33. A method of making a suspension mount, said method including:
providing a first outer container member,
providing a nonelastomeric center axial shaft and an outer elastomeric flexible seal cap with said outer elastomeric cap grounded radially outward to said first outer container member, said nonelastomeric center axial shaft longitudinally extending inward into said first outer container member along a shaft axis, with said nonelastomeric center shaft having a terminal end,
disposing a suspension mount damping liquid damper pumper member proximate said nonelastomeric center shaft terminal end,
providing an inner elastomeric intermediate assembly in said first outer container member between said suspension mount damping liquid damper pumper member and said outer cap member, said inner elastomeric assembly including an inner elastomeric member bonded with an inner nonelastomeric grounding member, said inner nonelastomeric grounding member grounding said inner elastomeric member with said first outer container member, with said inner elastomeric member extending inward from said container grounding member inward toward said shaft and separating said movable damping pumper from said flexible seal cap to provide a first flexible seal cap chamber and a second movable damping pumper chamber, said inner elastomeric assembly having at least a first liquid flow conduit between said first flexible seal cap chamber and said second movable damping pumper chamber to allow a flow of said liquid in a direction from said movable damping pumper towards said flexible seal cap and in an opposite direction from said flexible seal cap towards said movable damping pumper, said at least first liquid flow conduit distal from said nonelastomeric center axial shaft,
filling said first outer container member with a vehicle cab suspension mount damping liquid wherein said suspension mount damping liquid damper pumper member pumps said vehicle cab suspension mount damping liquid with said liquid flowing through said first liquid flow conduit distal from said nonelastomeric center axial shaft.

34. A method as claimed in claim 33 including proving a coil spring, and disposing said coil spring between said nonelastomeric center shaft terminal end and said first outer container member.

35. A method as claimed in claim 33 wherein said suspension mount damping liquid damper pumper is comprised of a suspension mount damping liquid damper pumper cupped member having a cup interior.

36. A method as claimed in claim 35, including providing a spring, said spring disposed between said nonelastomeric center shaft terminal end and said first outer container member with said spring received in said cup interior.

37. A method as claimed in claim 35, including providing a bolt and a bolt spacer and fixing said suspension mount damping liquid damper pumper cupped member to said shaft with said bolt and said bolt spacer, said bolt and said bolt spacer received in said cup interior.

38. A method as claimed in claim 35, including a bolt and a bolt spacer fixing said suspension mount damping liquid damper pumper cupped member to said shaft, and a suspension spring, said bolt, said bolt spacer, and said suspension spring received in said cup interior.

39. A method as claimed in claim 33 wherein said inner nonelastomeric grounding member includes a radially inwardly extending flange plate and a substantially normal axially extending extension.

40. A method as claimed in claim 33 wherein said inner elastomeric intermediate assembly inhibits liquid flow adjacent said shaft between said first flexible seal cap chamber and said second movable damping pumper chamber.

41. A suspension mount, including: a first outer container member, a nonelastomeric center axial shaft and means for controlling relative motion between said first outer container member and said nonelastomeric center axial shaft.

42. A suspension mount, including: a first outer container member, a nonelastomeric center axial shaft and means for controlling relative motion between said first outer container member and said nonelastomeric center axial shaft as shown and described.
